(19) United States
(12) Patent Application Publication
(10) Pub. No.: US 2010/0183954 A1
(43) Pub. Date: Jul. 22, 2010

(54) WATER MANAGEMENT IN A FUEL CELL

(75) Inventors: Nicolas Karst, Folkling (FR); Vincent Faucheux, Lans En Vercors (FR); Christelle Laugier, Rives (FR); Jean-Yves Laurent, Domene (FR)

Correspondence Address: STMicroelectronics Inc.;c/o WOLF, GREENFIELD & SACKS, P.C., 600 Atlantic Avenue, BOSTON, MA, 02210-2206, US

(73) Assignees: STMicroelectronics (Tours) SAS, Tours (FR); Commissariat A L'energie Atomique, Paris (FR)

(21) Appl. No.: 12/688,692

(22) Filed: Jan. 15, 2010

(30) Foreign Application Priority Data
Jan. 19, 2009 (FR) 09/50312

(51) Int. Cl. H01M 8/02

(52) U.S. Cl. 429/515

(57) ABSTRACT

A hydrogen-oxygen fuel cell including, on the anode side, a hydrogen storage buffer chamber. The buffer chamber includes a wall having at least a semi-permeable portion, impermeable to gases (hydrogen-oxygen-air) and permeable to water.

### CROSS REFERENCE TO RELATED APPLICATIONS

This application claims the priority benefit of French patent application number 09/50312, filed on Jan. 19, 2009, entitled “WATER MANAGEMENT IN A FUEL CELL,” which is hereby incorporated by reference to the maximum extent allowable by law.

### BACKGROUND OF THE INVENTION

1. Field of the Invention

The present invention relates to fuel cells, and especially to hydrogen-oxygen fuel cells, and more specifically relates to the management of water in a fuel cell.

Hydrogen-oxygen fuel cells are particularly well adapted to being installed in portable devices such as portable phones or computers.

2. Discussion of the Related Art

As illustrated in FIG. 1, a hydrogen-oxygen fuel cell comprises a layer or sheet of an electrolyte 1 sandwiched between two catalyst layers or sheets 3 and 4 coated with conductive layers 6 and 7 intended for contacting. The upper surface of the cell is in contact with oxygen, for example, the ambient air, and the lower surface of the cell is in contact with hydrogen. In such conditions, when the cell is connected to a load 8, a positive voltage appears on the upper surface side or cathode and a negative voltage appears on the lower surface side or anode and a current flows through the load. On the anode side, the catalyst transforms gaseous hydrogen molecules into two protons and two electrons, the protons travel from the anode catalyst layer, through the electrolyte layer, to the cathode catalyst layer where reaction 2H⁺+½0₂+2e−→H₂O takes place, both electrons flowing through the load.

Currently, electrolyte 1 is Nafion and catalyst 3, 7, is a carbon platinum mixture, for example comprising a few percents of platinum. The catalyst also preferably contains a given amount of Nafion, for example, from 20 to 40%.

Conductors 6 and 7 for example are very thin gold layers, to be at the same time conductive and permeable to hydrogen or oxygen. Conductors 6 and 7 may also be formed of gold grids.

The upper surface of the fuel cell may be free to be in contact with the ambient air. However, the lower surface must be protected to be only in contact with a hydrogen source. A buffer chamber 9 connected to a hydrogen source 5 is for example provided.

As indicated previously, the reaction occurring on the cathode side causes the generation of water. The water tends to cross the porous cathode catalyst, anode catalyst, and lower electrode layers 6 to be stored in hydrogen buffer layer 9, especially if the cell has to operate with a very high current density.

Thus, various drain systems have been devised to remove the water present in the buffer chamber and avoid “drowning” the cell. The systems provided up to now are complex systems implying the use of valves.

### SUMMARY OF THE INVENTION

An object of an embodiment of the present invention is to provide a system for managing the water in a hydrogen-oxygen fuel cell which is particularly simple and easy to implement.

Another object of an embodiment of the present invention is to provide a re-use of the water that may be diffused back into the buffer chamber.

Thus, an embodiment of the present invention provides a hydrogen-oxygen fuel cell comprising, on the anode side, a hydrogen storage buffer chamber, said chamber comprising a wall having at least a semi-permeable portion, impermeable to gases (hydrogen-oxygen-air) and permeable to water.

According to an embodiment of the present invention, the semi-permeable wall is made of Nafion.

According to an embodiment of the present invention, the semi-permeable wall is formed of a grid impregnated with Nafion.

According to an embodiment of the present invention, the semi-permeable wall comprises a Nafion sheet inserted between two grids.

According to an embodiment of the present invention, the semi-permeable wall communicates with a NaBH₄ chamber for generating hydrogen in the presence of water.

The foregoing objects, features, and advantages of the present invention will be discussed in detail in the following non-limiting description of specific embodiments in connection with the accompanying drawings.

### BRIEF DESCRIPTION OF THE DRAWINGS

FIG. 1 very schematically shows a conventional hydrogen-oxygen fuel cell;

FIG. 2 shows an embodiment of a hydrogen-oxygen cell according to an embodiment of the present invention; and

FIG. 3 shows an example of a hydrogen-oxygen fuel cell according to an embodiment of the present invention associated with a hydrogen generation cartridge.

### DETAILED DESCRIPTION

For clarity, the same elements have been designated with the same reference numerals in the different drawings and, further, as usual in the representation of integrated components, the various drawings are not to scale.

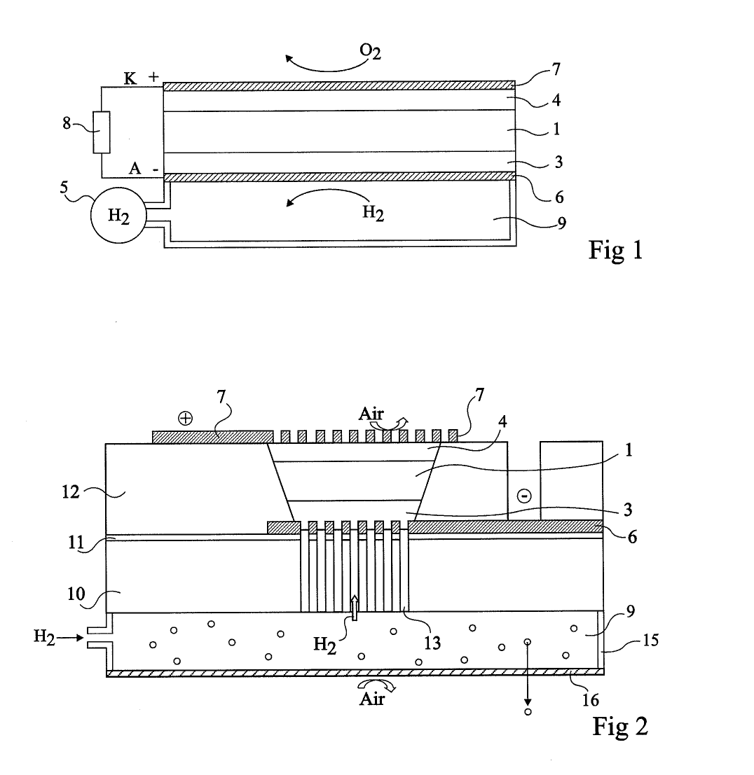

Generally speaking, at least one embodiment of the present invention provides replacing at least one wall or wall portion of chamber 9 of the cell illustrated in FIG. 1 with a semi-permeable material, permeable to water and impermeable to gases, in particular to hydrogen and air. Thus, the water vapor mixed with hydrogen in chamber 9 tends to migrate towards the surrounding air, provided that the ambient humidity ratio is lower than the humidity ratio created in chamber 9. This water vapor migration is favored by the fact that chamber 9 is in slight hydrogen overpressure with respect to the ambient air.

An example of a semi-permeable material is Nafion, which is a material currently used as a cell electrolyte material and which is thus available for a fuel cell manufacturer.

FIG. 2 shows an embodiment of a fuel cell using microelectronics techniques. The cell is formed on a silicon wafer 10 that may be coated with a first thin insulating layer 11 and with a second thicker insulating layer 12. An opening is formed in a portion of insulating layer 12. A catalyst layer 3, an electrolyte 1, and a second catalyst layer 4 (the thicknesses of insulating layer 12 and of layers 3, 1, and 4 may be such that at least some of layers 3, 1, and 4 extend widely beyond the opening) are successively deposited in this opening. A lower anode electrode 6 enables to take a contact on lower catalyst layer 3. An upper cathode electrode 7 enables to take a contact on upper catalyst layer 4. Electrodes 6 and 7 are provided with openings and channels 13 are formed in silicon wafer 10 opposite to the openings in the lower surface metallization. Further, a chamber 9 has been shown in the lower cell side, this chamber being used as a hydrogen buffer tank and being connected to a hydrogen source or to a hydrogen generation source.

This is an embodiment only. Various types of fuel cells that may be formed by the method illustrated in FIG. 2 are known in the art. For example, the silicon wafer portion which supports the actual fuel cell is preferably thinned down. This thinned-down portion of wafer 10 is bored with channels 13 letting through hydrogen. It should be understood that, generally, all wafer surfaces are coated with an insulator formed at least of native silicon oxide.

Catalyst layers 3 and 4 are formed by any means, for example, by inkjet deposition. Nafion layer 1 is for example spun on. In such a fuel cell, the power likely to be provided is especially proportional to the surface area taken up by the cell in the silicon wafer plane. Presently, the useful surface area of a fuel cell of the type described in relation with FIG. 2 is from 1 to 3 cm².

In the embodiment illustrated in FIG. 2, vertical walls 15 of chamber 9, orthogonal to the large side of the cell, are made of any selected material, for example, plastic matter, and bottom wall 16 of chamber 9 is made of a Nafion layer.

In practice, if it is considered that the Nafion sheet risks being too fragile, said Nafion sheet may be “reinforced”, that is, for example, formed around a metal grid. This sheet may also be surrounded by two metal grids. The metal grid(s) may for example be formed of a microperforated alumina sheet. FIG. 2 very schematically illustrates an embodiment of the present invention. In practice, a fuel cell will often comprise a plurality of fuel cells such as that illustrated in FIG. 2 assembled in a common package so that all upper surfaces are apparent and in contact with air and that all lower surfaces face a same hydrogen chamber. An example of such a package is given in European patent application EP-A-1939964 (B7988) filed by STMicroelectronics. Then, a wall or wall portion of this common chamber will be made of a semi-permeable material.

An additional advantage of at least one embodiment of the present invention is that the water escaping through the semi-permeable membrane may be recovered to be used in the provision of hydrogen. Indeed, in association with the hydrogen-oxygen fuel cells, rather than being formed of a pressurized hydrogen cartridge, the hydrogen source may be provided to be formed of a cartridge comprising sodium borohydride (NaBH₄) coupled with a water tank. To save the water contained in the water tank and decrease the size and the periodicity of the recharge of this tank, one may use, when present, the water escaping from the semi-permeable membrane.

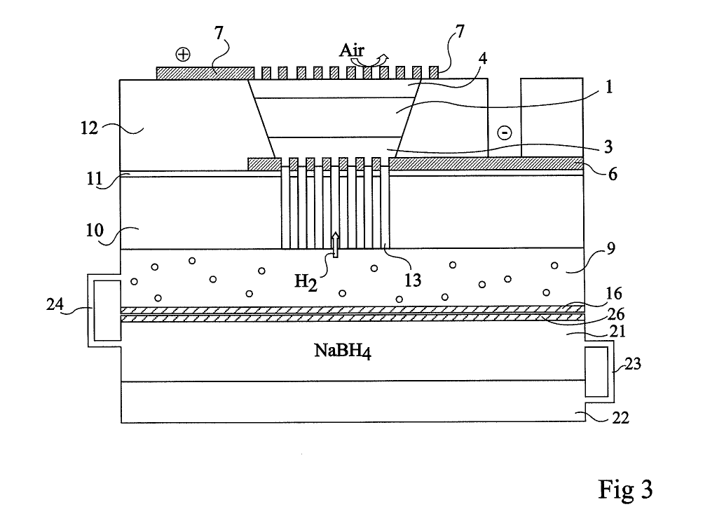

FIG. 3 shows an example of such an application. The upper portion of FIG. 3 corresponds to what is shown in FIG. 2. A hydrogen generation cartridge comprising a chamber 21 filled with NaBH₄ and a water tank 22 is provided under semi-permeable membrane 16. The water tank is coupled by a duct 23 to chamber 21. When hydrogen is desired to be provided, the water tank is placed under slight pressure so that the water penetrates into chamber 21 filled with NaBH₄. Hydrogen is generated and is transferred by a duct 24 into buffer chamber 9. Various known means comprising electrovalves are provided to ensure the operation of hydrogen generation device 21, 22.

As illustrated in FIG. 3, it may be provided for the upper portion of chamber 21 containing NaBH₄, or at least a portion of this upper portion, to also be formed of a semi-permeable membrane 26 arranged opposite to semi-permeable membrane 16. It may also be provided for the upper portion of chamber 21 to comprise an opening coming against semi-permeable membrane 16. Thus, when water escapes from chamber 9, it penetrates into the NaBH₄ reserve and takes part in the production of hydrogen by saving the water contained in tank 22.

The present invention is likely to have various alterations and modifications which will occur to those skilled in the art. In particular, various known types of hydrogen cells may be used. It may further be provided for chamber 9, instead of being an empty chamber, to be filled with a porous material such as porous silicon and it will then be easier to form semi-permeable membrane 16 on the lower surface of the porous silicon layer.

The present invention has been more specifically described in relation with embodiments relating to a specific embodiment of a fuel cell in which various materials are deposited in successive layers. The present invention also applies to the case where the cell is formed from sheets of the various materials placed against one another and for example assembled under pressure.

Various embodiments with different variations have been described hereabove. It will be within the abilities of those skilled in the art to combine various elements of these various embodiments and variations without showing any inventive step. Further, materials other than Nafion may be used for the electrolyte and materials other than carbon/platinum may be used for the catalyst, for example, carbon/platinum-cobalt or carbon/platinum-nickel.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A hydrogen-oxygen fuel cell comprising, on the anode side, a hydrogen storage buffer chamber, wherein said chamber comprises a wall having at least a semi-permeable portion, impermeable to gases (hydrogen-oxygen-air) and permeable to water.

2. The fuel cell of claim 1, wherein the semi-permeable wall is made of Nafion.

3. The fuel cell of claim 1, wherein the semi-permeable wall is formed of a grid impregnated with Nafion.

4. The fuel cell of claim 1, wherein the semi-permeable wall comprises a Nafion sheet inserted between the two grids.

5. The fuel cell of claim 1, wherein the semi-permeable wall is capable of communicating with a NaBH₄ chamber for generating hydrogen in the presence of water.
